(19) United States
(12) Patent Application Publication
(10) Pub. No.: US 2018/0187480 A1
(43) Pub. Date: Jul. 5, 2018

(54) DRIVING ASSEMBLY AND WINDOW BLIND

(71) Applicant: Huicai Zhang, Qingxin (CN)

(72) Inventor: Huicai Zhang, Qingxin (CN)

(21) Appl. No.: 15/906,223

(22) Filed: Feb. 27, 2018

(30) Foreign Application Priority Data
Nov. 15, 2017 (CN) 201721529874.1

(51) Int. Cl. E06B 9/36; F16H 19/06; F16H 19/00

(52) U.S. Cl. CPC E06B 9/368; F16H 19/005; F16H 19/06

(57) ABSTRACT

A driving assembly for window blinds includes a mounting plate, a driving wheel and a spring leaf wheel that are rotationally mounted on the mounting plate. The driving wheel is connected with a drive rod of a winding mechanism of a window blind, a spring leaf is arranged between the driving wheel and the spring leaf wheel, one end of the spring leaf is connected with the driving wheel, another end of the spring leaf is connected with the spring leaf wheel, and the driving wheel is driven by the drive rod to cause the spring leaf to tighten or relax thereby winding around the driving wheel or the spring leaf wheel. The driving assembly has simple structure and convenient assembly, and reliably provides a power for driving the winding wheels and the pull rope.

### RELATED APPLICATIONS

This application claims the benefit of priority to Chinese Utility Model Application No. 201721529874.1, filed Nov. 15, 2017, which is hereby incorporated by reference in its entirety.

### FIELD OF THE INVENTION

The present invention relates to window blinds, and more particularly to a driving assembly and a window blind including the same.

### BACKGROUND OF THE INVENTION

In conventional window blinds, multiple slats are connected trapezoidal ropes that are extended between a top rail and a bottom rail, one or more pull ropes run through the slats and extend from the bottom rail to the top rail. The bottom rail will be raised towards the top rail under an upward force applied to the pull rope, in such a way, the slats will be retracted from bottom to top. Due to restrictions of the blinds system and driving manner, the pull rope is longer than the total length of the window blinds after the window blinds are retracted, which brings potential strangulation hazard to children.

Cord-free window blinds are developed to solve the above problems, which use a spring driver as a driving source connected to a winding reel or a winding roller, and a pull rope wound around the winding reel or winding roller. On operation, the spring driver supplies a lift force to counteract the resultant force of the gravity of the slats and the force applied by a hand, by the means of balance force of the friction, the gravity, the force provided by the spring driver and the force applied the hand, the window blind can be retracted or extended at a desired position. However, the structure of the conventional spring driver is complicated, which is hard to assemble, further the applied force is unstable to make the movement of window blind unsmooth.

Thus, there is a need to provide an improved driving assembly and a window blind to overcome the drawbacks mentioned above.

### SUMMARY OF THE INVENTION

One objective of the present invention is to provide a driving assembly for window blinds, which has simple structure and convenient assembly, and reliably provides a power for driving the winding wheels and the pull rope.

Another objective of the present invention is to provide a window blinds with a driving assembly, which has simple structure and convenient assembly, and reliably provides a power for driving the winding wheels and the pull rope.

To achieve the above objectives, the present invention provides a driving assembly adapted for window blinds, which includes a mounting plate, a driving wheel and a spring leaf wheel that are rotationally mounted on the mounting plate. The driving wheel is connected with a drive rod of a winding mechanism of a window blind, a spring leaf is arranged between the driving wheel and the spring leaf wheel, one end of the spring leaf is connected with the driving wheel, another end of the spring leaf is connected with the spring leaf wheel, and the driving wheel is driven by the drive rod to cause the spring leaf to tighten or relax thereby winding around the driving wheel or the spring leaf wheel.

As an embodiment, a through hole is provided on the driving wheel, and the drive rod is inserted into the through hole.

Preferably, at least one rib is formed on an inner wall of the through hole, and at least one groove is formed on an outer wall of the drive rod to engage with the rib.

Preferably, two slots are respectively provided on the driving wheel and the spring leaf wheel, and two ends of the spring leaf are connected with the driving wheel and the spring leaf wheel by means of the slots.

The present invention provides a window blind including a top rail, multiple slats and a bottom rail that are movable relative to the top rail, a driving assembly mounted in the top rail to actuate the slats and the bottom rail, and a winding mechanism including a drive rod and a winding wheel configured on the drive rod. The driving assembly includes a mounting plate, a driving wheel and a spring leaf wheel that are rotationally mounted on the mounting plate. The driving wheel is connected with a drive rod of a winding mechanism of a window blind, a spring leaf is arranged between the driving wheel and the spring leaf wheel, one end of the spring leaf is connected with the driving wheel, another end of the spring leaf is connected with the spring leaf wheel, and the driving wheel is driven by the drive rod to cause the spring leaf to tighten or relax thereby winding around the driving wheel or the spring leaf wheel.

In comparison with the prior art, the driving assembly of the present invention applies the driving wheel, the spring leaf wheel and the spring leaf to supply lifting force for counteracting the resultant force of the gravity of the slats and the force applied by a hand, in such a way, the structure is simple, the assembly is convenient, and the power is reliable, thereby simplifying the manufacturing process and reducing the manufacturing cost.

### BRIEF DESCRIPTION OF THE DRAWINGS

The accompanying drawings facilitate an understanding of the various embodiments of this invention. In such drawings:

FIG. 1 is a partial perspective view of a window blind according to one embodiment of the present invention;

FIG. 2 is a perspective view of a top rail of the window blind according to one embodiment of the present invention;

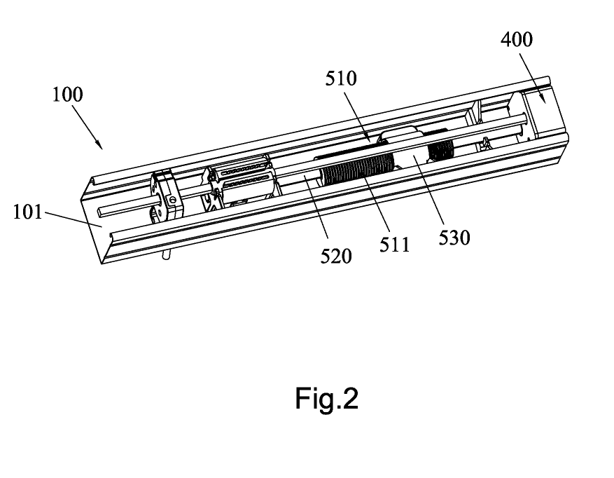

FIG. 3 is a partial exploded view of FIG. 2; and

FIG. 4 is a partial perspective view of a driving assembly of a window blind according to one embodiment of the present invention;

### DETAILED DESCRIPTION OF ILLUSTRATED EMBODIMENTS

Various preferred embodiments of the invention will now be described with reference to the figures, wherein like reference numerals designate similar parts throughout the various views.

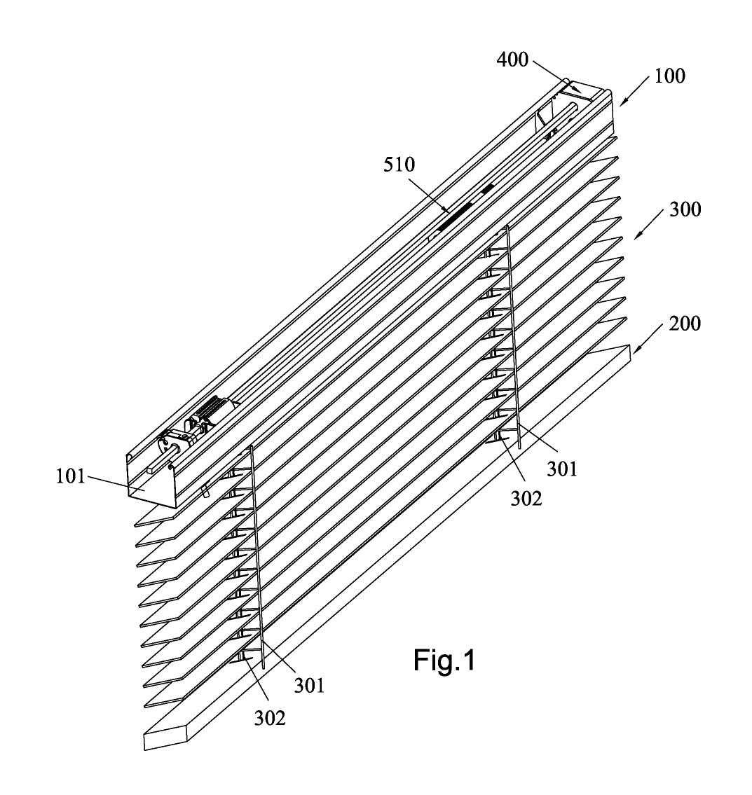

Referring to FIG. 1, a window blind 1 includes a top rail 100, a bottom rail 200 and multiple slats 300 connected between the top rail 100 and the bottom rail 200. The slats 300 will be extended if the bottom rail 200 is pulled down by a hand and will be folded if the bottom rail 200 is lifted up by a hand.

The slats 300 are connected and supported by a trapezoidal rope 301 extended between the top rail 100 and the bottom rail 200, and a pull rope 302 is extended from the bottom rail 200 to the top rail 100, runs through the slats 300 and winds around the driving assembly 400. As shown in FIG. 1, the driving assembly 400 is fixed to a U-shape rail 101 (as shown, partially) of the top rail 100, which is adapted for actuating the slats 300 and the bottom rail 100. Specifically, the top rail 100 of the window blind 1 further includes a winding mechanism 510 and a drive rod 520 connected with the driving assembly 400 and the winding mechanism 510, and the pull rope 302 is wound on a winding wheel 511 of the winding mechanism 510 and connected with the slats 300. Once the slats 300 are raised up or pulled down, the pull rope 302 will be retracted or extended under the force of the hand, the winding mechanism 510 and the driving assembly 400, thereby the slats 300 and the bottom rail 100 will be retracted or extended. Preferably, the winding mechanism 510 is further provided with a slat angle adjuster 530 connected with the pull rope 302 and the winding mechanism 510, so as to adjust the tilting angle of the slats 300.

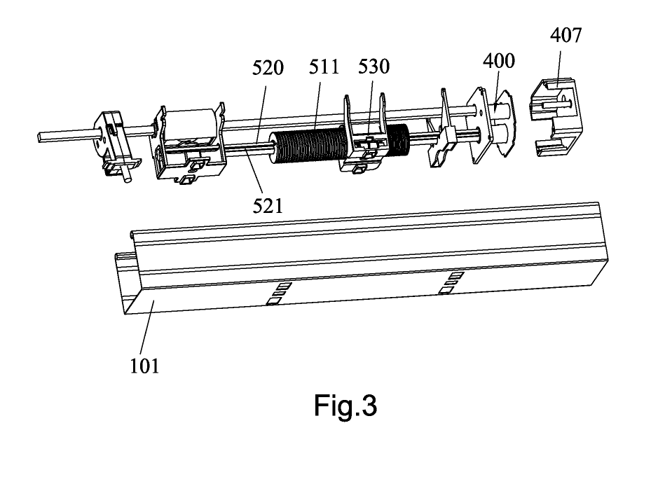

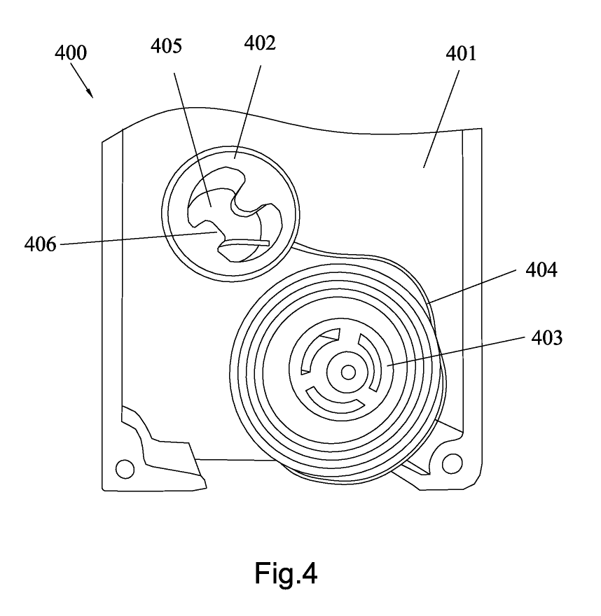

Specifically, as shown in FIGS. 3 and 4, the driving assembly 400 includes a mounting plate 401, a driving wheel 402 and a spring leaf wheel 403 that are rotationally mounted on the mounting plate 401. The driving assembly 400 is mounted on the end of the top rail, and the driving wheel 402 is connected with the drive rod 502. Preferably, the driving wheel 402 and the spring leaf wheel 403 are pivotally mounted on the mounting plate 401, such as by means of bearings. A spring leaf 404 is arranged between the driving wheel 402 and the spring leaf wheel 403, one end of the spring leaf 404 is connected with the driving wheel 402, and another end of the spring leaf 404 is connected with the spring leaf wheel 403. Preferably, slots (not shown) are respectively formed on the driving wheel 402 and the spring leaf wheel 403, and two ends of the spring leaf 404 are connected with the driving wheel 402 and the spring leaf wheel 403 by means of the slots. The spring leaf 404 can be wound around the driving wheels 402 and/or the spring leaf wheel 403 according to the actual facts. For example, when the slats 300 of the window blind is pulled down, the winding wheel 511 is rotated accordingly to make the pull rope 302 disengage from the winding wheel 511, meanwhile the driving wheel 402 is rotated to cause the spring leaf 404 to tighten to wind on the driving wheel 402 from the spring leaf wheel 403. When the slats 300 of the window blind is raised up, the winding wheel 511 is rotated reversely to make the pull rope 302 wind on the winding wheel 511 in turns, meanwhile the driving wheel 402 is rotated reversely to cause the spring leaf 404 to release from the driving wheel 402 and wind on the spring leaf wheel 403 in turns. Preferably, the spring leaf 404 is a coil spring which will be wound on the spring leaf wheel 403 in a first working mode and wound on the driving wheel 402 in a second working mode, and wound on the both wheels during the change between the two modes. The driving wheel 402, the spring leaf wheel 403 and the spring leaf 404 supply a lift force to counteract the resultant force of the gravity of the slats and the force applied by a hand.

Preferably, a through hole 405 is provided on the driving wheel 402, and the drive rod 502 is inserted into the through hole 405. More preferably, at least one rib 406 is formed on an inner wall of the through hole 405, and at least one groove 521 (referring to FIG. 3) is formed on an outer wall of the drive rod 502 to engage with the rib 406. For example, two symmetrical ribs 406 and two symmetrical grooves 521 are provided. In such an engaging manner, the connection between the drive rod 520 and the driving wheel 402 is simple and reliable.

Preferably, the driving assembly 400 further includes a housing 407.

The driving assembly 400 of the present invention applies the driving wheel 402, the spring leaf wheel 403 and the spring leaf 404 to supply lifting force for counteracting the resultant force of the gravity of the slats and the force applied by a hand, in such a way, the structure is simple, the assembly is convenient, and the power is reliable, thereby simplifying the manufacturing process and reducing the manufacturing cost.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A driving assembly, adapted for window blinds, the driving assembly comprising a mounting plate, a driving wheel and a spring leaf wheel that are rotationally mounted on the mounting plate, the driving wheel being connected with a drive rod of a winding mechanism of a window blind, wherein a spring leaf is arranged between the driving wheel and the spring leaf wheel, one end of the spring leaf is connected with the driving wheel, another end of the spring leaf is connected with the spring leaf wheel, and the driving wheel is driven by the drive rod to cause the spring leaf to tighten or relax thereby winding around the driving wheel or the spring leaf wheel.

2. The driving assembly according to claim 1, wherein a through hole is provided on the driving wheel, and the drive rod is inserted into the through hole.

3. The driving assembly according to claim 2, wherein at least one rib is formed on an inner wall of the through hole, and at least one groove is formed on an outer wall of the drive rod to engage with the rib.

4. The driving assembly according to claim 1, wherein two slots are respectively provided on the driving wheel and the spring leaf wheel, and two ends of the spring leaf are connected with the driving wheel and the spring leaf wheel by means of the slots.

5. A window blind, comprising a top rail, multiple slats and a bottom rail that are movable relative to the top rail, a driving assembly mounted in the top rail to actuate the slats and the bottom rail, and a winding mechanism comprising a drive rod and a winding wheel configured on the drive rod, wherein the driving assembly comprises a mounting plate, a driving wheel and a spring leaf wheel that are rotationally mounted on the mounting plate, the driving wheel is connected with the drive rod, a spring leaf is arranged between the driving wheel and the spring leaf wheel, one end of the spring leaf is connected with the driving wheel, another end of the spring leaf is connected with the spring leaf wheel, and the driving wheel is driven by the drive rod to cause the spring leaf to tighten or relax thereby winding around the driving wheel or the spring leaf wheel.

6. The window blind according to claim 5, wherein a through hole is provided on the driving wheel, and the drive rod is inserted into the through hole.

7. The window blind according to claim 6, wherein at least one rib is formed on an inner wall of the through hole, and at least one groove is formed on an outer wall of the drive rod to engage with the rib.

8. The window blind according to claim 5, wherein two slots are respectively provided on the driving wheel and the spring leaf wheel, and two ends of the spring leaf are connected with the driving wheel and the spring leaf wheel by means of the slots.

9. The window blind according to claim 5, wherein the driving assembly is arranged at an end of the drive rod, and the winding mechanism is arranged beside the driving assembly.

10. The window blind according to claim 5, wherein a slat angle adjuster is provided on the winding wheel.
